(19) United States
(12) Patent Application Publication
(10) Pub. No.: US 2017/0039646 A1
(43) Pub. Date: Feb. 9, 2017

(54) SYSTEM FOR MONITORING INVESTMENTS

(71) Applicant: GAL LACHOVITZ, TEL AVIV (IL)

(72) Inventor: GAL LACHOVITZ, TEL AVIV (IL)

(21) Appl. No.: 14/994,183

(22) Filed: Jan. 13, 2016

Related U.S. Application Data
(60) Provisional application No. 62/201,617, filed on Aug. 6, 2015.

(51) Int. Cl. G06Q 40/04

(52) U.S. Cl. CPC G06Q 40/04

(57) ABSTRACT

A system and method for providing information to investors in securities or commodities of a subscriber, the system including at least one sensor disposed for sensing and collecting data in real time corresponding to at least one selected physical characteristic of the subscriber's monitored physical asset, an asset information server including non-volatile storage means for storing the collected data of physical characteristics of the monitored assets of the subscriber, and a communications network coupling each sensor and asset information server, for transferring the detected data about the asset, means in the server for the subscriber to subscribe to the system for storing information about their assets in the asset information server, and means for permitting access to pre-selected kinds of stored data to investors and potential investors in the subscribers.

### FIELD OF THE INVENTION

The present invention relates to monitoring investments, in general and, in particular, to a system for keeping track of assets and commodities.

### BACKGROUND OF THE INVENTION

There are many different types of investments available to investors in various markets and exchanges. These investments include stocks, bonds and various commodities. The investor goes to the appropriate market in order to get a stake in a company, bond issuer or commodity. Typically, investors are able to follow the value of the company, bond issuer or type of commodity. However, they are not able to keep track of physical assets belonging to the organization in which the investor has invested.

An asset is a resource with economic value that an individual, corporation or country owns or controls with the expectation that it will provide future benefit, e.g., that it can generate, or be converted to, a cash flow. A commodity is a basic good used in commerce for which there is a demand, but which is supplied without qualitative differentiation across a market, i.e., that is interchangeable with other goods of the same type. The quality of a given commodity may differ slightly, but it is essentially uniform across producers. Thus, the market treats each good in the category as fungible (equivalent, or nearly so), with no regard to who produced it.

One of the characteristics of a commodity good is that its price is determined as a function of its market as a whole. Well-established physical commodities have actively traded spot and derivative markets. These markets will quickly respond to changes in supply and demand to find an equilibrium price and quantity. On a commodity exchange, it is the underlying standard stated in the contract that defines the commodity, not any quality inherent in a specific producer's product. Commodity trading in the exchanges typically requires agreed-upon standards, so that trades can be executed without visual inspection. In this way, an investor can avoid buying 100 units of cattle only to find out that the cattle are sick, or discovering that sugar purchased is of inferior or unacceptable quality. Thus, when they are traded on an exchange, commodities must meet specified minimum standards, also known as a basis grade.

The commodities markets typically follow basic economic principles: lower supply equals higher prices. Commodities can quickly become risky investment propositions because they can be affected by eventualities that are difficult, if not impossible, to predict. These include unusual weather patterns, natural disasters, epidemics and man-made disasters. However, investors can only follow market patterns and statistics. Thus, investing in commodities can quickly degenerate into gambling or speculation when a trader makes uninformed decisions, based on the sparse information available to him.

When trading securities and commodities, each trade has to be recorded and settled. Every time equities are bought or sold, company records have to be updated, while money and shares are transferred from one owner to another. This used to be conducted manually. Share certificates were posted, checks were sent back and forth and share registers were updated. The process used to take around two weeks, after which trades were ‘settled’, meaning that the investor who bought the shares became the legal owner and money left his or her account and arrived in the account of whoever had sold the shares.

In the past, trading of securities and commodities was accomplished by individuals working on a trading floor or trading over the phone. Nowadays, almost every transaction is conducted electronically and electronic trading is rapidly replacing human trading in global securities markets. Electronic trading makes transactions easier to complete, monitor, clear, and settle. In addition, there exist a number of electronic communication networks (ECN), automated systems for trading stocks away from a stock exchange. ECNs typically act as passive order-matching systems, matching buy and sell orders that have the same prices for the same number of shares. Unlike stock exchanges, ECNs do not employ specialists or market-makers to coordinate trades. An advantage of an ECN is that it displays orders in real time, whereas on the NY Stock Exchange, most investors are limited to only viewing the best bid and ask prices.

Investors have no access to real-time data concerning the assets they want to invest in through the various markets, which could help them in making buy and sell decisions. All they know is what is offered for sale, sell and buy prices of stocks and commodities and what they read in newspapers, magazines and written annual reports published by the companies or economic magazines.

Accordingly, there is a long felt need for real-time information for investors provided by the companies, bond issuer or the commodity provider regarding physical assets held by the organization in which they invested, and/or commodities in which they have interest. Furthermore, it would be very desirable if those investing in commodities or companies could have an opportunity to determine the state of the actual goods or company assets before and while investing in them, in order to make more educated decisions.

### SUMMARY OF THE INVENTION

The present invention relates to a system and method for providing information to investors by monitoring, as by sensing or measuring, at least one physical characteristic of a physical asset associated with the investment or belonging to the asset owner. Thus, the system includes at least one physical asset or commodity associated with an investment, the asset having a physical characteristic that can be monitored by at least one sensor. The sensor is disposed in a location permitting collection of data collectable by that sensor and senses and collects data in real time corresponding to at least one selected physical characteristic of the subscriber's monitored physical asset. The sensors are coupled by a communications network to an asset information server including non-volatile storage means for transferring the detected data about the asset for storage on the server. The collected data of physical characteristics of the monitored assets of the subscriber is stored in the server, associated with information identifying the asset owner and an indication of the time at which the data was collected. The server includes means, such as a software module, by which subscribers can subscribe to the system for storing information about their assets in the asset information server, and means for permitting access to pre-selected kinds of stored data to investors and potential investors as permitted by the subscribers.

The asset information server stores and provides access to the information it receives about the physical assets. This information is supplied by the asset owner, who is a subscriber to the system. For purposes of this application, a subscriber is any stock company, bond issuer, such as a municipality or a company, commodity market, or the like, who is registered as a subscriber to the system of the present invention. Present or potential investors or stock- or bondholders are granted access to some or all of the information in the server by the asset owner. The asset information server may be coupled to a market server or other computer or central processing unit of a market or exchange where transactions of buying and selling securities and commodities are performed. This computer can which provide user names and access codes received from the asset information server to investors for access to the data stored in the asset information server. The information can be accessed directly or through the market server or another server arranged to control access. Alternatively, the market or exchange gives access to investors through brokerage servers, and not directly.

According to some embodiments, the transmitter transmits all the time, so real-time information is always available. In some embodiments, the system is a coded system, so only a security/commodity owner can receive information and, as soon as a transaction is completed, the new owner, only, is enabled to receive information. A server in a brokerage house or in a corporation that holds the register of ownership would also store the individual access codes of each investor, or the parties to the contract, in the case of commodities. Alternatively, a different level of information can be made available to brokers and potential investors, who are considering investing in the commodity or company or municipality or other bond issuer. The system may include sensors or detectors or other collection or measurement devices configured and disposed to sense or measure a physical characteristic of at least one asset associated with the investment.

### BRIEF DESCRIPTION OF THE DRAWINGS

The present invention will be further understood and appreciated from the following detailed description taken in conjunction with the drawings in which:

FIG. 1 is a schematic illustration of a system for monitoring assets, constructed and operative in accordance with one embodiment of the present invention; and

FIG. 2 is a block diagram illustration of a method for monitoring assets, according to one embodiment of the invention.

### DETAILED DESCRIPTION OF THE INVENTION

The present invention provides information to current and potential investors who are remote from the subject of their investment and have no way to understand what is happening on a daily basis, e.g., how the company is functioning. The present invention makes the investment tangible by providing investors with real time physical evidence regarding physical characteristics of assets owned by their investments and permits them to follow day to day operation of the company and to see the state of its assets.

The is accomplished by providing a system and method for permitting an investor to monitor or keep track of physical characteristics of the physical assets of an asset owner (organization, company, commodity market, municipality, bond issuer) in which he or she is interested in investing or has invested, in order to receive additional information, which is made available by the asset owner, about the state of the assets. This can be, for example, the health and wellbeing of live assets or maintenance and management of non-living assets. This is particularly relevant for commodities, which can move, grow, change their status or their health. In addition, real-time monitoring of physical assets of corporations, rather than just reviewing the descriptive articles, quarterly and annual reports and dry statistics they publish, permits investors to follow the instantaneous activity or actions of the company or bond issuer to see the state of the company or commodity in reality. This added information can be invaluable in permitting the investor to make a better informed decision regarding investment in the company or commodity. For example, if an investor is considering purchasing corn in two months, then physical characteristics of the corn today will give an indication as to whether this is a profitable investment. Or, if an investor is interested in a shipping company, the number of ships that are in commercial use will help the potential investor determine whether this is the time to invest or not. Some of the information can be made available to potential buyers, while additional information can be made available to current owners, so both can make more informed purchase and sale decisions. In other words, it may be desirable to differentiate between different members in the market who would receive different pre-selected kinds of information or for whom separate sets of criteria can be defined, e.g., depending on their stake in the company.

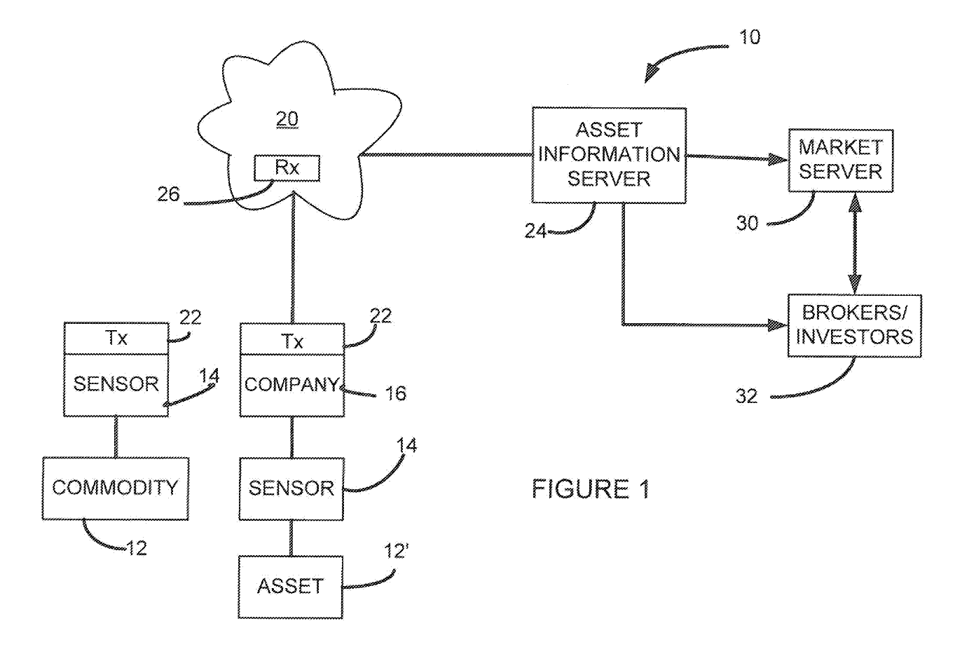

The present invention relates to a system and method for monitoring investments by monitoring at least one physical characteristic of a physical asset associated with or belonging to the investment. Referring to FIG. 1, there is shown a schematic illustration of a system 10 for monitoring assets, constructed and operative in accordance with one embodiment of the present invention. System 10 includes at least one commodity 12 or physical asset 12′ associated with an investment or potential investment, the asset having at least one physical characteristic that can be monitored by a sensor. In the case of a company 16 or bond issuer, the asset belongs to or is associated with the company or bond issuer. At least one sensor 14 or detector of physical data relating to the physical asset 12, 12′ is provided, for monitoring selected physical data of asset 12, 12′. Preferably, the sensors 14 collect in real time this data continuously or periodically at pre-set time intervals.

The system further includes a communications network 20, here illustrated as including a transmitter 22 coupled via another communication system to each sensor 14, for transmitting detected physical data about asset 12, 12′. Sensor 14 can be any appropriate sensor, detector, or other gauge or data collection or measurement device configured and disposed to sense, measure or detect in real-time the selected physical characteristic of asset 12, 12′ associated with the investment and provide information corresponding thereto. Such physical characteristics can include physical geographic location or movement of trucks, ships, cattle, for example, or the appearance of pests on crops, quantity of water in a crop's soil, number of objects produced on a production line in a given period of time, etc. These characteristics can be monitored in any known manner, including, but not limited to, GPS, health monitor (breathing, heart rate, body temperature, etc.), pedometers or other devices for counting steps or measuring distance travelled, a thermometer, a digital imaging camera or thermal digital imaging camera, and any other device that can collect and quantify a physical characteristic.

The communication network 20 is also in communication with an asset information server 24, which stores the information it receives from the detectors 14 about the physical asset. Different kinds of information can be made available to investors to enhance the dry numerical information provided in accounting statements. The kinds of data available to various investors or potential investors is pre-selected by each subscriber. In this way, investors can follow, in real time, physical operations of the subscriber (asset owner). This information can be made available directly from the asset information server or via the market server 30 or through a brokerage server (not shown). For purposes of the present application, the term “investor” refers both to present, actual investors and potential future investors.

The asset information server 24 includes a receiver 26 arranged to receive electronic information from the transmitter 22 to permit remote monitoring of the asset 12, 12′. The asset information server 24 may be coupled to a market server 30 or other computer or processing unit at one of a number of possible venues, for accessing by an investor 32. The asset information server can be part of a communications network of the company offering shares, itself, part of a brokerage house, an Electronic Communication Network (ECN), an investment advisor's office, and/or any other location where investors go to seek information about securities and/or commodities. Asset information server 24 accommodate asset owners who would subscribe to the system so as to display physical characteristics of their assets to investors, or potential commodity sellers. Preferably, different pre-selected kinds of information in the asset information server are made available by the subscribers and are accessible by a customer, potential investor, and/or broker on a device having components to store and/or display the information, to permit the investor or the advisor to follow one or more physical characteristics of the asset and/or monitor its whereabouts.

At least some of the physical information provided to the asset information server preferably is stored with access only by a code for viewing only by stockholders or current investors, while other information can be made available to the general public and potential investors. The information accessible only by code would only be made available to a registered stock or bond or commodity owner. As soon as a transaction is completed, the old owner is removed or downgraded in the asset information server, and the new owner is given a code to access the information. If desired, there can also be differentiation regarding the information made available, i.e., depending on the class of securities in which they invested. In addition, a different level of information than that available to current investors can be made available to brokers and potential investors, who are considering investing in the commodity or company. If the investor has invested in a specific commodity, the investor will be provided with access to information about the entire class of commodity. If the investment is in a stock or bond, in a company having a collection of physical assets, then the owner will receive information of physical characteristics of the assets in that category or group, that was collected by the various sensors or detectors of the system, to enable him or her to make better informed business decisions. A server in a brokerage house or in a corporation that holds the register of ownership could also store the individual access codes of each investor and the parties to the contract, in the case of commodities.

It will be appreciated that classes of securities or collections of commodities can be created that specifically include access to this additional information. Thus, companies who wish to participate can offer for sale stock, shares or bonds associated with assets that are capable of being monitored.

According to some embodiments, the information from the asset information server can be accessed by an interactive platform, such as a social application. In this case, investors can view and compare their assets with their friends' assets. The platform can include a smart phone application, so that the investor can look at or monitor his assets at all times.

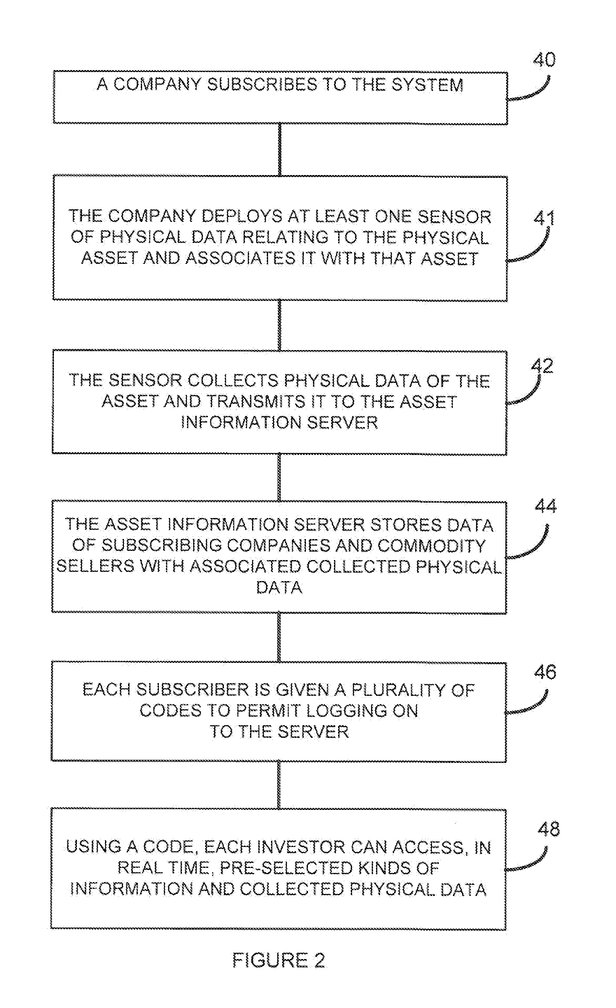

One method of operation of the monitoring system of the present invention will now be described with reference to FIG. 2, a block diagram illustration of a method for monitoring assets, according to some embodiments of the invention. A company that is seeking investors or a provider of commodities decides that it is willing to provide pre-selected kinds of data regarding its physical assets in order to attract investors. The company or other asset owner subscribes to the asset monitoring system (block 40). The subscriber deploys at least one sensor or detector of data of a physical characteristic relating to the physical asset and associates it with that asset (block 41). The sensor is deployed in a location permitting collection of data collectable by that sensor. For example, a GPS chip may be placed on trucks, or a breathing sensor on cattle, and so on. The sensor or detector collects data of the physical characteristic of the asset and transmits it over the communication network to the asset information server (block 42). Preferably, an indication of the time at which the data was collected is stored in the server together with the data.

For example, suppose a potential investor is interested in investing in a shipping company. In this case, a GPS chip, or other geographical locator, and/or any other appropriate sensor, detector, camera, etc., to detect other physical characteristics can be placed on each ship owned by a company. In this way, information can be collected, individually, about each ship owned by the company, for viewing by the investor and, possibly, comparing with other companies. This collected information can be selected from, for example, the harbor in which the ship is anchored, the length of time required for loading and unloading, which goods are loaded or unloaded from the ship, where it is sailing or has sailed, its route, the weather, and so forth. Preferably, the collected information is made available in real time. Each subscriber can decide over what time period the collected information will remain available. In any event, preferably, the collected information is made available together with an indication of the time of collection.

The asset information server stores data of various companies and/or commodity sellers who subscribe to the system (block 44). The server also stores the received data of physical attributes or characteristics of the assets, together with contact particulars about the owners. Upon subscribing, the system provides subscribers with at least one code (for example, username and password) to be distributed to their registered investors (block 46). These codes can be distributed directly by the subscriber to recorded security holders or commodity purchasers, or through the brokerage server, whereby each is given a unique username and password to login to the server. Alternatively, each recorded security or commodity purchaser is assigned a username and password permitting access to the level of information available to that particular class of investors of the asset owner. Using their unique usernames and passwords, the investors are given access to the pre-selected kinds of information and physical data that have been collected in real time (block 48). Preferably, the time of collection is stored together with the collected data to inform the investor of the actual time of collection and make it possible for him or her to see changes of a particular characteristic over time. Preferably, authentication is performed by the system and can be implemented in any suitable manner. Alternatively, the collected information that each subscriber makes available to the public can be accessed without a code.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A system for providing information to investors in securities or commodities of a subscriber, the system comprising:
at least one sensor, disposed in a location permitting collection of data collectable by the at least one sensor, for sensing and collecting data in real time corresponding to at least one selected physical characteristic of the subscriber's monitored physical asset;
an asset information server including non-volatile storage means for storing said collected data of physical characteristics of the monitored assets of the subscriber; and
a communications network coupling each said sensor and said asset information server, for transferring the detected data about the asset;
means in the server for the subscriber to subscribe to the system for storing information about their assets in the asset information server; and
means for permitting access to pre-selected kinds of stored data to investors and potential investors in the subscribers.

2. The system according to claim 1, wherein the data is stored in the asset information server together with an indication of a time of detection.

3. The system according to claim 1, wherein the means for permitting access is configured to permit access to additional pre-selected kinds of data to security holders and commodity purchasers.

4. The system according to claim 1, wherein said asset information server is coupled to a central processing unit of a market or exchange where transactions of buying and selling securities and commodities are performed.

5. The system according to claim 4, wherein the asset information server is accessible through at least one brokerage server.

6. The system according to claim 1, wherein said at least one sensor is selected from the group including: a sensor, detector, or other gauge or data collection or measurement device configured and disposed to sense, measure or detect in real-time the selected physical characteristic of asset.

7. The system according to claim 6, wherein the at least one sensor is selected from the group including: a GPS chip, a geographical locator, GPS, health monitor (breathing, heart rate, body temperature, etc.), pedometer or other device for counting steps or measuring distance travelled, a thermometer, a digital imaging camera or thermal digital imaging camera.

8. A method of providing information to an investor, the method comprising:
subscribing to a system including an asset information server including non-volatile storage means to become a subscriber;
deploying at least one sensor in a location permitting collection of data collectable by said at least one sensor regarding at least one physical characteristic of at least one physical asset of the subscriber;
sensing and collecting data in real time corresponding to said at least one selected physical characteristic of said at least one physical asset of the subscriber;
storing said collected data in the asset information server, the collected data being associated with information about the subscriber and a time of collection of the data; and
permitting access to said stored data to investors and potential investors in the subscriber.

9. The method according to claim 7, wherein the step of permitting access includes providing to an investor at least one code issued to the subscriber.

10. The method according to claim 9, wherein the step of providing including providing one code to permit access to pre-selected kinds of information and providing a different code to permit access to different pre-selected kinds of information.

11. The method according to claim 8, wherein the step of providing access includes providing access via a central processing unit of a market or exchange where transactions of buying and selling securities and commodities are performed coupled to said asset information server.

12. The method according to claim 8, wherein the step of providing access includes providing access to said asset information server through at least one brokerage server.

13. The method according to claim 8, wherein the data is stored in the asset information server together with an indication of a time of detection.
